(19) United States
(12) Patent Application Publication
(10) Pub. No.: US 2008/0295103 A1
(43) Pub. Date: Nov. 27, 2008

(54) DISTRIBUTED PROCESSING METHOD

(75) Inventors: Toshihiro Shimizu, Kawasaki (JP); Nobutaka Imamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/123,275

(22) Filed: May 19, 2008

(30) Foreign Application Priority Data
May 24, 2007 (JP) 2007-138218

(51) Int. Cl. G06F 9/46

(52) U.S. Cl. 718/102

(57) ABSTRACT

According to an aspect of an embodiment, a method for controlling a processing device for distributing jobs among a plurality of job processing devices for executing said jobs, respectively, said job including a plurality of job files, the method comprises: determining said job processing devices for executing said job files, respectively; generating an execution file to be executed by first job processing device after first job file is executed by said first job processing device, said execution file when executed having said first job processing devise requests second job processing device to execute second job file, said second job file being executed by said second job processing device subsequently to said second job file executed by said first job processing device; and transferring said first job file and said execution file to said first job processing device.

### BACKGROUND OF THE INVENTION

1. Field of the Invention

This invention relates to distributed processing.

2. Description of the Related Art

A distributed processing system is a processing system in which a plurality of computers connected via a network interactively perform communications therebetween and perform processing on processing requests (jobs). One such distributed processing system uses grid-computing technology.

In grid-computing technology, jobs are submitted to computing apparatuses (hereinafter referred to as job-processing apparatuses) that are dispersedly located over a wide area and that execute job processing. In general, a hardware structure (such as the type of central processing unit (CPU), a memory capacity, and a disk capacity), a software structure of an operating system (OS) installed, and an administrator are different among job-processing apparatuses. A job-processing apparatus that executes job processing in a grid computing system needs to be under certain conditions required to execute the job processing. It is unrealistic that all job-processing apparatuses connected in the grid computing system have hardware and software for executing job processing. Thus, users need to select job-processing apparatuses capable of executing job processing operations. A distributed processing apparatus causes a job-processing apparatus that matches certain apparatus-type information set by a user to execute a job processing operation. A technique related to the above techniques is disclosed in PCT Japanese Translation Patent Publication No. 2007-500387 and Japanese Laid-open Patent Publication No. 2001-92641.

However, since users specify, for each job, information regarding the type of job-processing apparatus, the job cannot be performed by job-processing apparatuses having information regarding the different type of job-processing apparatus. As a result, the distributed processing apparatus cannot perform load balancing of job processing.

### SUMMARY

According to an aspect of the embodiment provides a method for controlling a processing device for distributing jobs among a plurality of job processing devices for executing the jobs, respectively, the job including a plurality of job files. The processing device determines the job processing devices for executing the job files, respectively. The processing device generates an execution file to be executed by one of the job processing devices after one of the job files is executed by the one of the job processing devices, the execution file when executed having the one of the job processing devises requests another of job processing devices to execute another of job files, said another of job files being executed by said another of the job processing devices subsequently to the job file executed by the one of the job processing devices. The processing device transfers the one of the job files and the execution file to the one of the job processing devices.

### BRIEF DESCRIPTION OF THE DRAWINGS

FIG. 1 is a block diagram of a grid computing system;

FIG. 2 is a block diagram of hardware of a management server;

FIG. 3 is a diagram of an exemplary structure of a job-processing apparatus table;

FIG. 4 is a block diagram of hardware of a job-processing apparatus;

FIG. 5A and FIG. 5B are a sequence diagram showing the flow of job processing;

FIG. 6 is a diagram showing an exemplary structure of a job-processing request;

FIG. 7 is a flowchart of processing in which the management server determines a job-processing apparatus;

FIG. 8 is a diagram showing an exemplary structure of a job-processing execution request;

FIG. 9 is a diagram showing an exemplary structure of a job program;

FIG. 10 is a flowchart of processing in which the management server generates the job program;

FIG. 11 is a flowchart of moving processing of job processing executed by a first job-processing apparatus; and

FIG. 12 is a diagram showing an example of job processing.

### DESCRIPTION OF THE PREFERRED EMBODIMENTS

According to an aspect of the embodiment, a distributed processing apparatus executes distributed processing in which a plurality of job-processing apparatuses are caused to execute a plurality of processing operations constituting a job.

According to the aspect of the embodiment, the distributed processing apparatus receives execution files in which job-execution commands corresponding to the processing operations are described and condition information regarding job-processing apparatuses capable of executing the processing operations. For each of the processing operations, the distributed processing apparatus determines one of the job-processing apparatuses that executes the processing operation on the basis of the condition information. An execution file is sent to a certain job-processing apparatus. The sent execution file causes the certain job-processing apparatus to send, to another job-processing apparatus, a request for performing a certain processing operation other than the processing operation performed by the certain job-processing apparatus.

The execution file for performing the certain processing operation may be sent to the job-processing apparatus that executes the certain processing operation.

Identification information regarding the determined job-processing apparatus and information regarding the name of the execution file may be sent to the certain job-processing apparatus that executes the processing operation.

The distributed processing apparatus may further receive information regarding the processing order of the processing operations of the job, and send, to the job-processing apparatus, information regarding the request of the certain processing operation that is first listed in the information regarding the processing order.

The processing operation first performed in the job may be described in a command line interpreter.

According to the aspect, a job in which a processing operation other than a processing operation performed by a job-processing apparatus is changed so as to move to another job-processing apparatus can be sent to the job-processing apparatus. As a result, according to aspects, a distributed processing program, a distributed processing apparatus, and a distributed processing method capable of causing different-structured job-processing apparatuses to execute a plurality of processing operations constituting a job can be provided.

In the following description, a job is a unit of processing input by a user and accepted by a grid computing system 1. A job processing operation included in a job is a unit of processing executed by a job-processing apparatus 20.

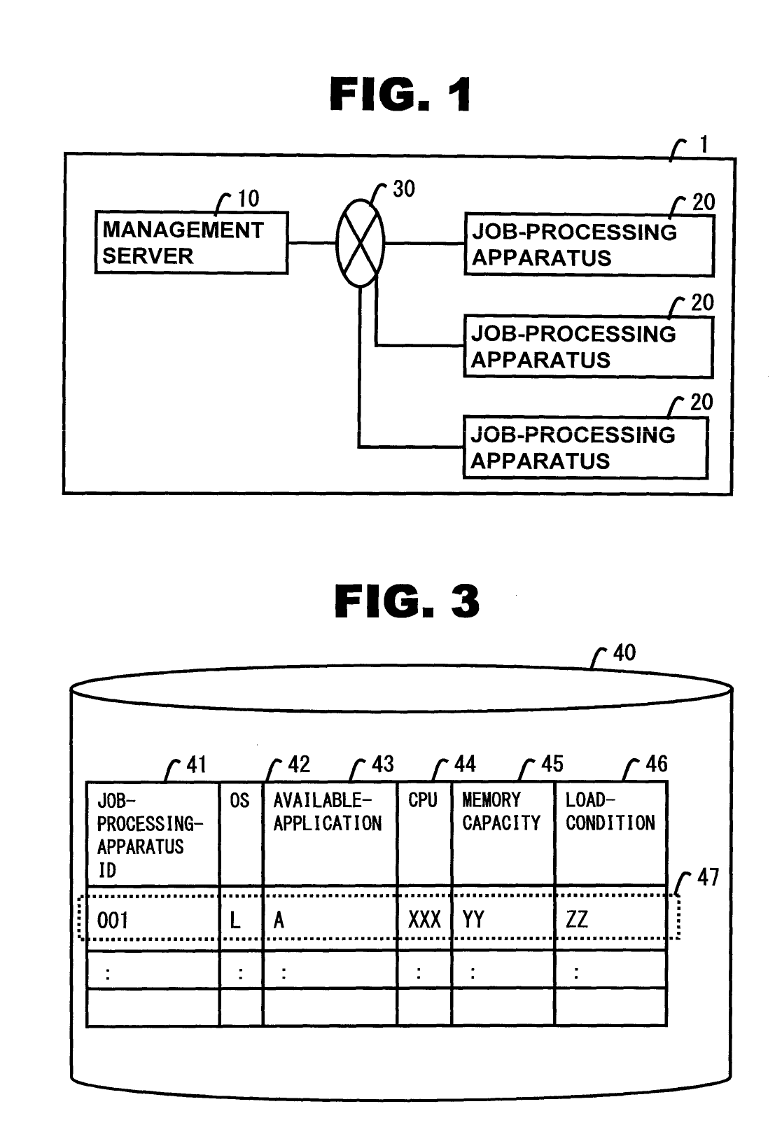

Embodiments will be described below. FIG. 1 is a block diagram of the grid computing system 1. The grid computing system 1 has a structure in which a management server (a distributed processing apparatus) 10 for managing job processing operations and job-processing apparatuses 20 for executing the job processing operations are connected via a network 30. The network 30 includes, for example, a local area network (LAN) and the Internet.

In an embodiment, a certain computing apparatus in the grid computing system 1 is the management server 10 and computing apparatuses in the grid computing system 1 are the job-processing apparatuses 20. The management server 10 sends a job-processing request to one of the job-processing apparatuses 20. Here, each of the job-processing apparatuses 20 in the grid computing system 1 according to the embodiment may be different in terms of processing performance, temporary memory capacity, storage capacity, OS, and the like.

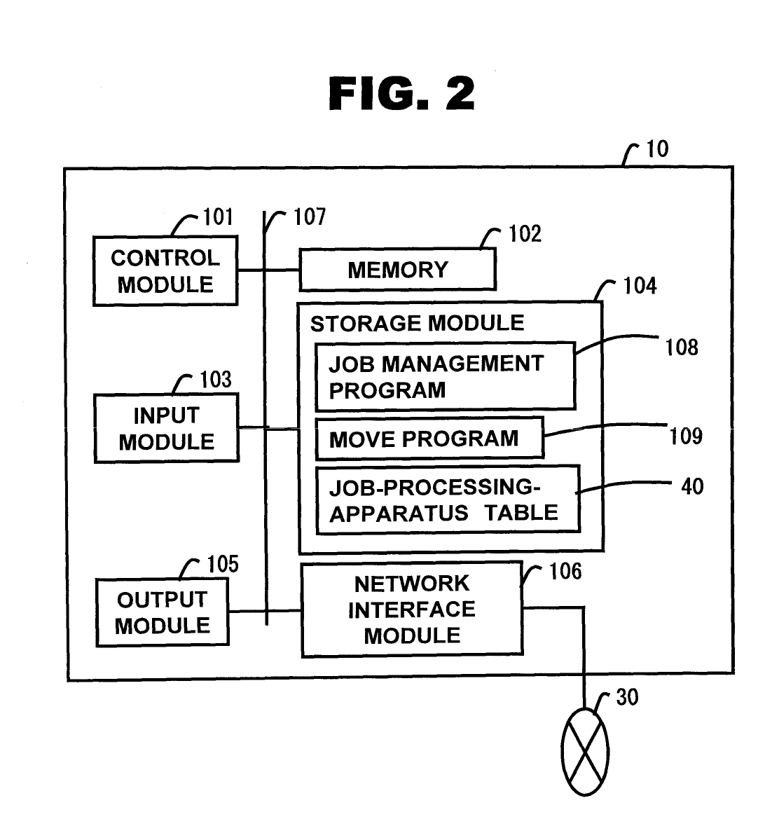

A hardware structure of the management server 10 (processing device) will be described. FIG. 2 is a diagram showing a hardware structure of the management server 10. The management server 10 has a structure in which a control module 101, a memory 102, an input module 103, a storage module 104, an output module 105, and a network interface module 106 are connected to a bus 107.

The control module 101 controls the entirety of the management server 10. The control module 101 is, for example, a CPU. Moreover, the control module 101 executes a job management program 108 stored in the memory 102. The job management program 108 causes the control module 101 to function as, for example, a module that selects a job-processing apparatus 20 used for executing job processing, a module that sends a job-processing request to the job-processing apparatus 20, a module that generates input information regarding a move program 109, and a module that replaces the filename of the move program 109 with the name of a job execution file.

The memory 102 is a storage area which is used as a workspace for executing the job management program 108 stored in the storage module 104. Moreover, the memory 102 is a storage area used to store various computation results generated when the job management program 108 is executed by the control module 101. The memory 102 is, for example, a random access memory (RAM).

The input module 103 accepts a job-processing request 17 from a user, the job-processing request 17 to be subjected to processing of a job input by the user. The input module 103 includes, for example, a keyboard, a mouse, and a touch panel. The job-processing request 17 can be input via the network 30 from a user terminal connected to the network 30. The output module 105 outputs information regarding a result of job processing. Such a result of the job processing can be output via the network 30 to a user terminal.

The output module 105 is, for example, a display (a display apparatus). The job management program 108, a table regarding job-processing apparatuses (hereinafter referred to as a “job-processing-apparatus table”) 40, the job-processing request 17, the move program 109, and the like are stored in the storage module 104. The storage module 104 is, for example, a hard disk drive. The network interface module 106 is connected to the network 30 and sends and receives various information to and from the job-processing apparatuses 20 (job processing device).

The job-processing-apparatus table 40 included in the management server 10 will be described. FIG. 3 shows an exemplary structure of the job-processing-apparatus table 40. The job-processing-apparatus table 40 is a table in which states of the job-processing apparatuses 20 managed by the management server 10 are stored. The job-processing-apparatus table 40 includes records 47. Each of the records 47 is constituted of job-processing-apparatus identification information 41, OS information 42, available-application (APP) information 43, CPU information 44, memory capacity information 45, and load-condition information 46.

The job-processing-apparatus identification information 41 is information for identifying each of the job-processing apparatuses 20. The OS information 42 is information regarding the type of OS used by the job-processing apparatus 20. The available-APP information 43 is information regarding the type of application software owned by the job-processing apparatus 20. The CPU information 44 is information regarding the type of CPU used by the job-processing apparatus 20. The memory capacity information 45 is information regarding a memory capacity usable when the job-processing apparatus 20 performs job processing. The load-condition information 46 is information regarding a load condition of the job-processing apparatus 20 and is obtained from the job-processing apparatus 20.

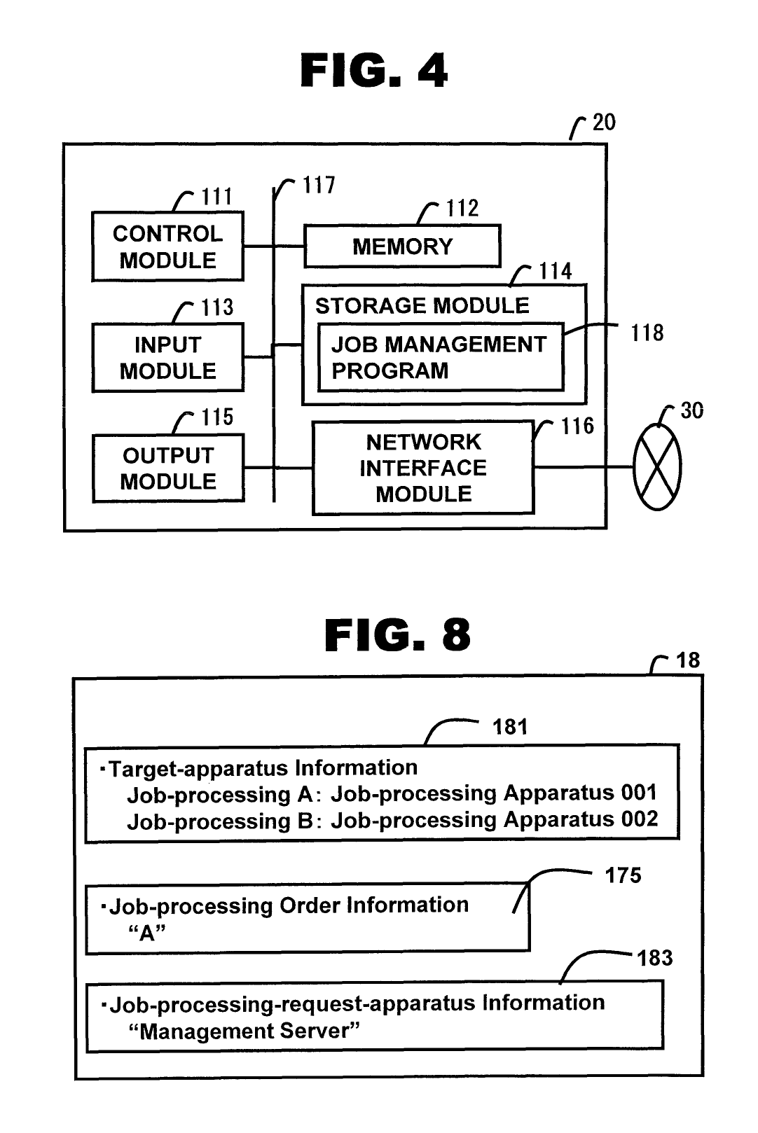

The hardware structure of the job-processing apparatuses 20 will be described. FIG. 4 is a block diagram showing a hardware structure of each of the job-processing apparatuses 20. The job-processing apparatus 20 has a structure in which a control module 111, a memory 112, an input module 113, a storage module 114, an output module 115, and a network interface module 116 are connected to a bus 117.

The control module 111 controls the entirety of the job-processing apparatus 20. The control module 111 is, for example, a CPU. Moreover, the control module 111 executes a job processing file by executing a job management program 118 stored in the memory 112. The job management program 118 causes the control module 111 to function as a module that executes job processing.

The memory 112 is a storage area which is used as a workspace for executing the job management program 118 stored in the storage module 114. Moreover, the memory 112 is a storage area used to store various computation results generated when the job management program 118 is executed by the control module 111. The memory 112 is, for example, a RAM.

The input module 113 includes, for example, a keyboard, a mouse, and a touch panel. The output module 115 is, for example, a monitor. The job management program 118 is stored in the storage module 114. The job-processing request 17 including information regarding a job execution file 171, information regarding a job-procedure file 172, information regarding an input-data file 173 necessary for job processing, and the like are stored in the storage module 114. The storage module 114 is, for example, a hard disk drive. The network interface module 116 is connected to the network 30 and sends and receives various information to and from the management server 10 and another job-processing apparatus 20.

Next, the flow of processing from when the job-processing request 17 is input to when a result of the job-processing is output in the grid computing system 1 will be described.

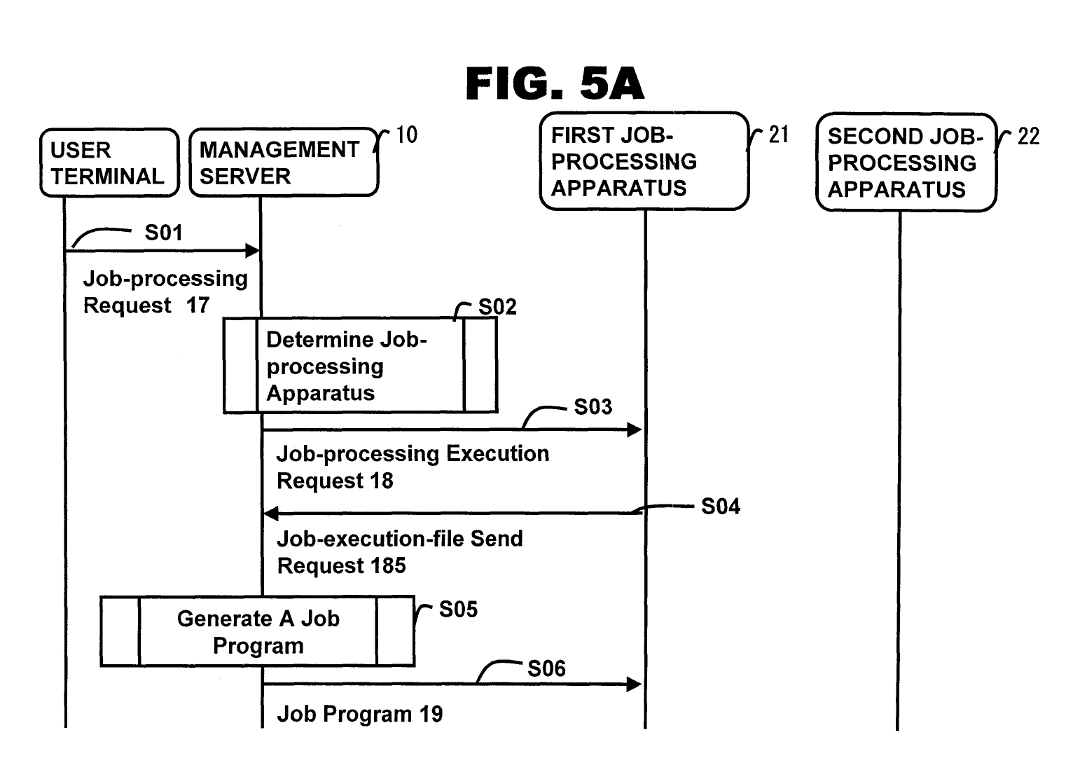

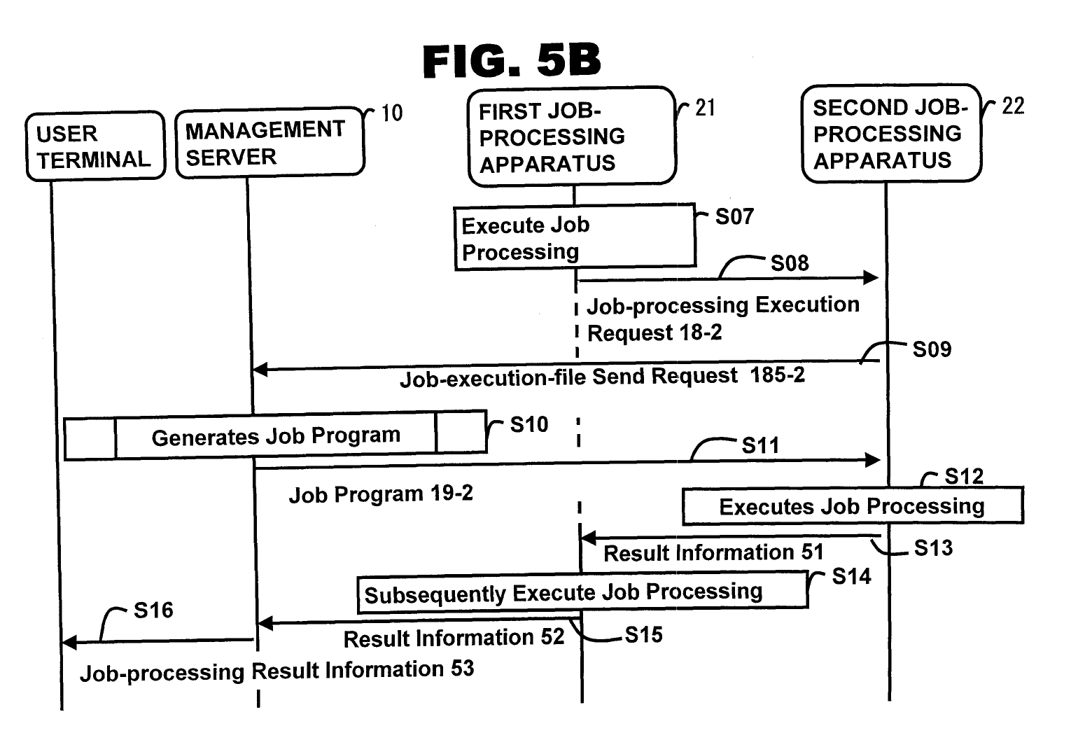

FIG. 5A and FIG. 5B are sequence diagrams showing the flow of job processing.

First, a user registers the job-processing request 17 to the management server 10. In FIG. 5A and FIG. 5B, the user registers the job-processing request 17 from a user terminal to the management server 10 via the network 30.

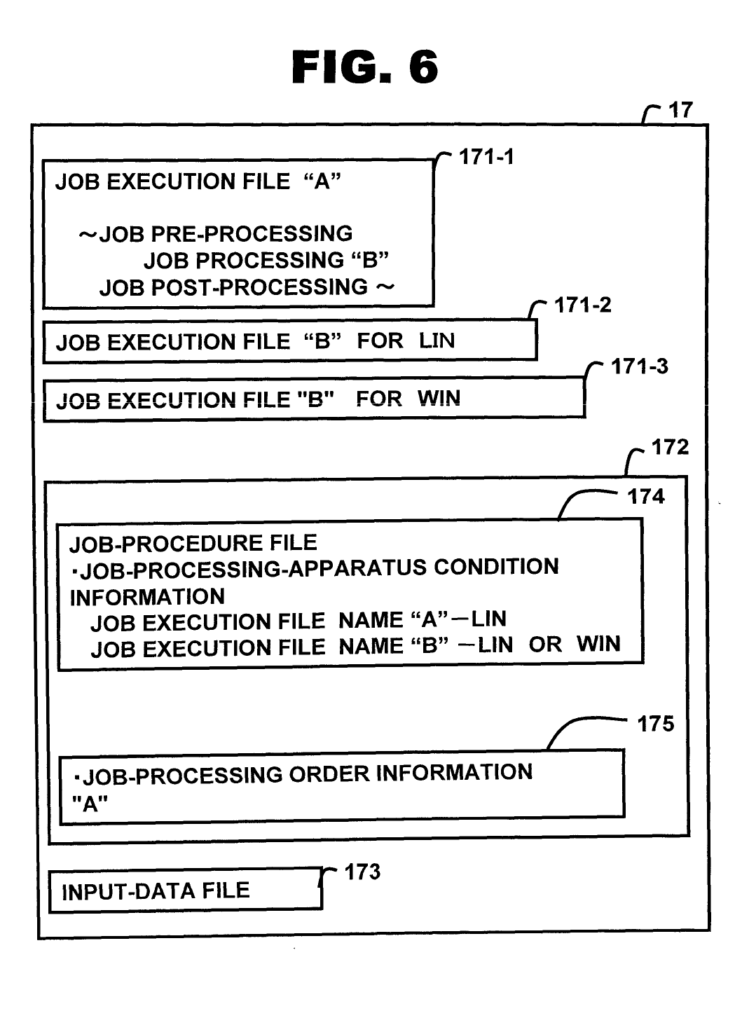

FIG. 6 is a diagram showing an exemplary structure of the job-processing request 17.

The job-processing request 17 includes the job execution file 171, the job-procedure file 172 showing a procedure of job processing, and the input-data file 173 necessary for job processing. Here, if input data is not necessary for performing job processing, the input-data file 173 is not necessary. The job-processing request 17 may include a plurality of job processing operations. If the job-processing request 17 includes a plurality of job processing operations, the job execution file 171 is provided to each of the job processing operations.

The job execution file 171 is a file which includes an execution command causing a job-processing apparatus 20 to execute a job processing operation. For example, the job execution file 171 may be a binary file readable by the job-processing apparatus 20. The job execution file 171 may be a text file. The job execution file 171 in text format is processed as a command interpreter. The command interpreter reads text included in the job execution file 171, converts the text into a processing command capable of being read by an OS or application software, and provides the processing command to the OS or the application software. Such a command interpreter is, for example, a shell. If the command interpreter is a shell, a job execution file to be subjected to processing is a shell script. In FIG. 6, the job execution file 171 includes a job execution file “a” 171-1, a job execution file “b” 171-2, and a job execution file “b” 171-3. Executing the job execution file “a” 171-1 shown in FIG. 6 performs job pre-processing and job post-processing. Executing the job execution file “a” 171-1 also performs a job processing operation “b” between the pre-processing and the post-processing.

The job-procedure file 172 includes information regarding a procedure of the job processing. In the job-procedure file 172, information regarding the first job-processing operation to be executed among a plurality of job processing operations is defined as job-processing order information 175. The job-procedure file 172 includes job-processing-apparatus condition information 174 in which condition information regarding a job-processing apparatus 20 capable of executing the job processing operation specified by the job execution file 171 and the job execution file 171 are linked. FIG. 6 shows that a processing operation “a” specified by the job execution file “a” 171-1 is executable on Linux® OS. FIG. 6 also shows that a job processing operation “b” specified by the job execution file “b” 171-2 is executable on Linux® OS and the job processing operation “b” specified by the job execution file “b” 171-3 is executable on Windows® OS. The job-processing-apparatus condition information 174 includes, for example, a memory capacity capable of being used for performing a job processing operation, a storage capacity capable of being used for a job-processing apparatus to perform the job processing operation, and the type of OS used by the job processing apparatus, and the types of application software that the job processing apparatus has. Here, the job-processing request 17 in this embodiment does not specify the job-processing apparatus 20 itself. The job-processing request 17 includes condition information regarding job-processing apparatuses 20 capable of executing the job processing.

A plurality of job execution files 171 can be executed to perform the same job processing operation. For example, the job execution file “b” 171-2 executable on Linux® OS and the job execution file “b” 171-3 executable on Windows® OS can be executed to perform the same job processing operation.

Referring back to the sequence diagram shown in FIG. 5A, in step S01, the management server 10 obtains the job-processing request 17 via the network 30 from the user terminal. In step S02, the management server 10 determines, on the basis of the job-processing request 17, one of the job-processing apparatuses 20 that executes the job processing.

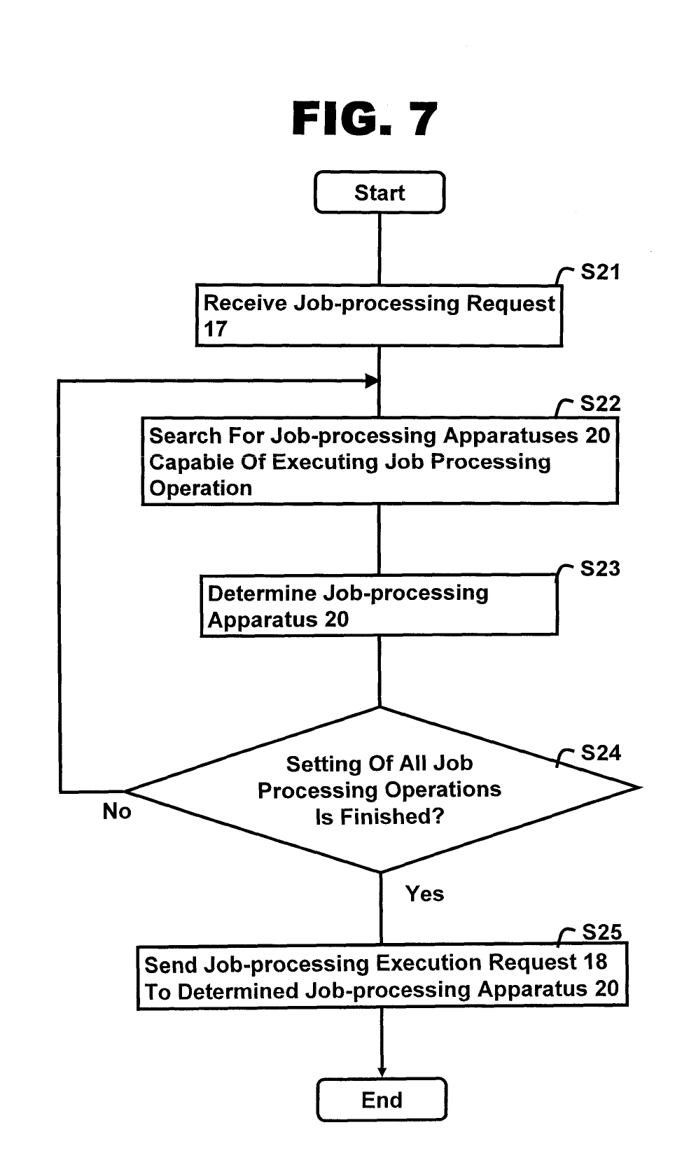

Here, the processing performed by the management server 10 in step S02, the processing being performed to determine the job-processing apparatus 20, will be described. FIG. 7 is a flowchart of processing in which the management server 10 determines the job-processing apparatus 20.

In this embodiment, the management server 10 allocates all processing operations included in the job-processing request 17 to job-processing apparatuses 20.

In step S21, the management server 10 receives the job-processing request 17 in step S02. According to the following processing in steps S22 through S24, for each job processing operation included in the job-procedure file 172, the management server 10 determines the job-processing apparatus 20 used to execute the job processing operation.

In step S22, the management server 10 searches for job-processing apparatuses 20 capable of executing the job processing operation. That is, the management server 10 searches for job-processing apparatuses 20 that satisfy the job-processing-apparatus condition information 174 regarding the job processing operation, on the basis of the records 47 in the job-processing-apparatus table 40.

In step S23, the management server 10 determines the job-processing apparatus 20 used to execute the job processing operation among the job-processing apparatuses 20 that are obtained in step S22 as the result of the search. For example, in order to determine the job-processing apparatus 20 that executes the job processing operation, the management server 10 compares the job-processing apparatuses 20 in terms of the severity of the present processing load on the basis of the load-condition information 46 in the job-processing-apparatus table 40, or in terms of the processing performance.

In step S24, the management server 10 performs processing of steps S22 and S23 until the setting of all the job processing operations included in the job-processing request 17 is finished. In step S25, the management server 10 sends a job-processing execution request 18 to the determined job-processing apparatus 20. The management server 10 sends the job-processing execution request 18 to the job-processing apparatus 20 that executes the job processing operation indicated by the job-processing order information 175.

FIG. 8 is a diagram showing an exemplary structure of the job-processing execution request 18.

The job-processing execution request 18 includes target-apparatus information 181 in which job processing operation and a job-processing apparatus 20 that executes the job processing operation are linked, the job-processing order information 175, and information 183 indicating an apparatus that sends a job-processing request (hereinafter referred to as “job-processing-request-apparatus information 183”).

The job-processing-request-apparatus information 183 is identification information regarding an apparatus that sends a job-processing request. For example, in step S03 shown in FIG. 5A, the management server 10 is the apparatus that sends a job-processing request.

For each job processing operation, in step S02 shown in FIG. 5A, the management server 10 determines the job-processing apparatus 20 that executes the job processing operation. For brevity, a first job-processing apparatus 21 and a second job-processing apparatus 22 are defined among a plurality of job-processing apparatuses 20 connected to the grid computing system 1. The job-processing apparatus 20 that receives the job-processing execution request 18 from the management server 10 is the first job-processing apparatus 21. The first job-processing apparatus 21 executes job processing. The first job-processing apparatus 21 may send a job-processing request to another job-processing apparatus 20. In this case, the job-processing apparatus 20 that receives the job-processing execution request 18 from the first job-processing apparatus 21 is the second job-processing apparatus 22. For the following description, please refer to FIG. 5A and FIG. 5B again.

In step S03, the management server 10 sends the job-processing execution request 18 to the first job-processing apparatus 21. In step S04, after the reception of the job-processing execution request 18, the first job-processing apparatus 21 sends a job-execution-file send request 185 to the management server 10. The job-execution-file send request 185 sent includes the identification information regarding the first job-processing apparatus 21. Moreover, the job-execution-file send request 185 may include the job-processing execution request 18 received in step S04.

In step S05, the management server 10 generates a job program 19 that the first job-processing apparatus 21 needs in order to execute the job processing. The job program 19 includes a job execution file 191, a job-procedure file 192, and an input-data file 193.

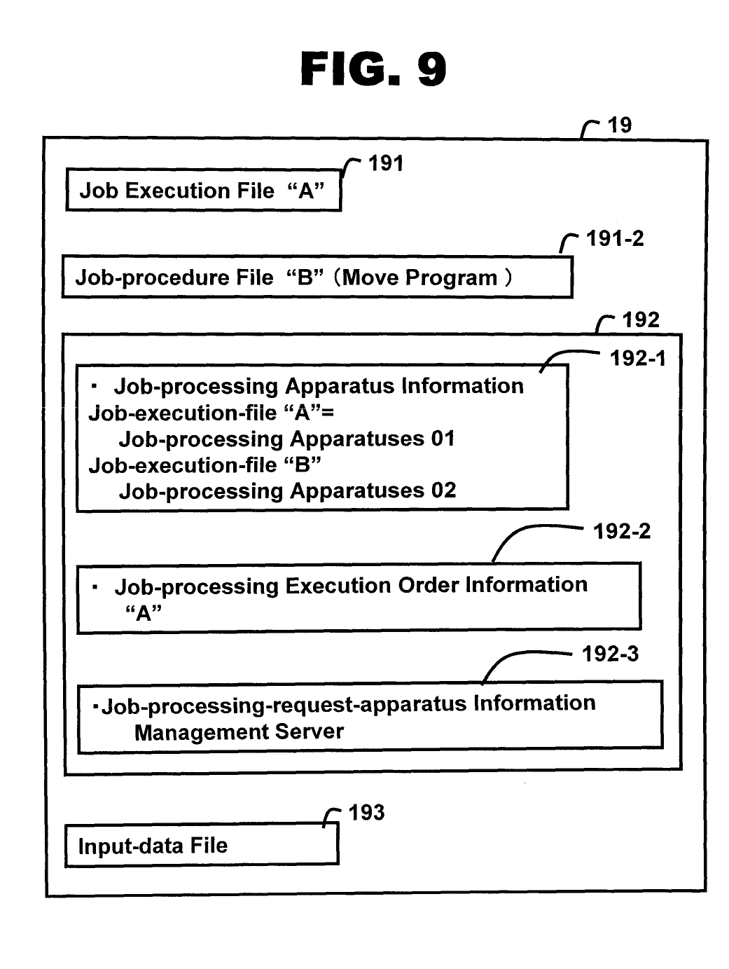

FIG. 9 is a diagram showing an exemplary structure of the job program 19. The job program 19 includes the job-procedure file 192, the input-data file 193, a job execution file 191-1 of the job processing that the first job-processing apparatus 21 executes, and a move program 191-2 whose name is changed to the name of a job execution file of job processing that another job-processing apparatus 20 executes.

The job-procedure file 192 includes identification information 192-1 regarding a job-processing apparatus 20 that executes job processing, information 192-2 regarding the job-processing execution order, and identification information 192-3 regarding an apparatus that sends a job-processing request.

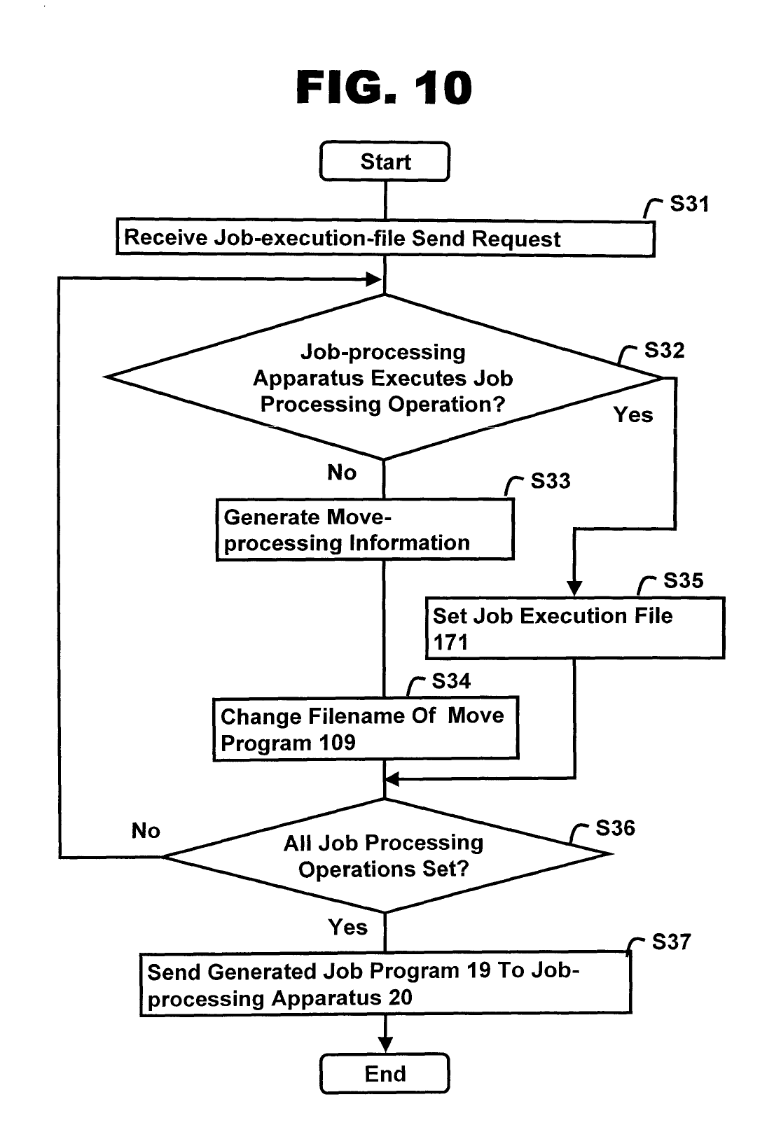

Here, the processing in step S05 in which the management server 10 generates the job program 19 will be described. FIG. 10 is a flowchart of the processing in which the management server 10 generates the job program 19.

In step S31, the management server 10 receives the job-execution-file send request 185 from one of the job-processing apparatuses 20. In FIG. 5A and FIG. 5B, in step S31, the management server 10 receives the job-execution-file send request 185 from the first job-processing apparatus 21. For each job processing operation, in accordance with the processing performed in steps S32 through S35, the management server 10 determines or generates the job-execution file 191 sent to the first job-processing apparatus 21.

In step S32, the management server 10 determines whether the job processing operation should be executed by the job-processing apparatus 20 that has sent the job-execution-file send request 185. In FIG. 5A and FIG. 5B, the management server 10 determines whether the first job-processing apparatus 21 should execute the job processing operation. The management server 10 obtains the identification information regarding the first job-processing apparatus 21, the identification information being included in the job-execution-file send request 185. The management server 10 obtains target-apparatus information 181 included in the job-processing execution request 18. By comparing the above-described pieces of information, the management server 10 can determine whether the first job-processing apparatus 21 should execute the job processing operation.

If the job processing operation is determined to be executed by the job-processing apparatus 20 that has sent the job-execution-file send request 185 (YES in step S32), in step S35, the management server 10 performs the setting of the job execution file 171 as the file to be sent to the job-processing apparatus 20. If the job processing operation is determined not to be executed by the job-processing apparatus 20 that has sent the job-execution-file send request 185 (NO in step S32), in step S33, the management server 10 generates move-processing information to be input in the move program 109.

In step S34, the management server 10 changes the filename of the move program 109. The management server 10 changes the filename of the move program 109 to the filename of the job execution file 171 corresponding to the job processing operation designated in the processing performed in steps 32 through 34.

In step S36, the management server 10 executes the processing performed in steps S32 through S35 until the setting of all the job processing operations in the job-processing execution request 18 is finished. In step S37, the management server 10 sends the generated job program 19 to the job-processing apparatus 20 from which the job-execution-file send request 185 is received. In FIG. 5A and FIG. 5B, in step S06, the management server 10 sends the generated job program 19 to the first job-processing apparatus 21.

The management server 10 sends the input-data file 193 as necessary. The management server 10 can send the input-data file 193 as, for example, a standard input data file.

In step S06, the management server 10 sends a job file that the first job-processing apparatus 21 needs in order to execute the job processing.

In step S07, the first job-processing apparatus 21 executes the job processing. The job processing includes a processing operation in which the job processing is moved to another job-processing apparatus 20. The first job-processing apparatus 21 executes the move program 109.

Here, the move program 109 will be described. The move program 109 is a program prestored in the management server 10. The move program 109 causes the job-processing apparatus 20 to function as means to execute setting processing of input information necessary for the job processing, sending processing of a job-processing request, waiting processing during the job processing, and obtaining processing of the job processing result.

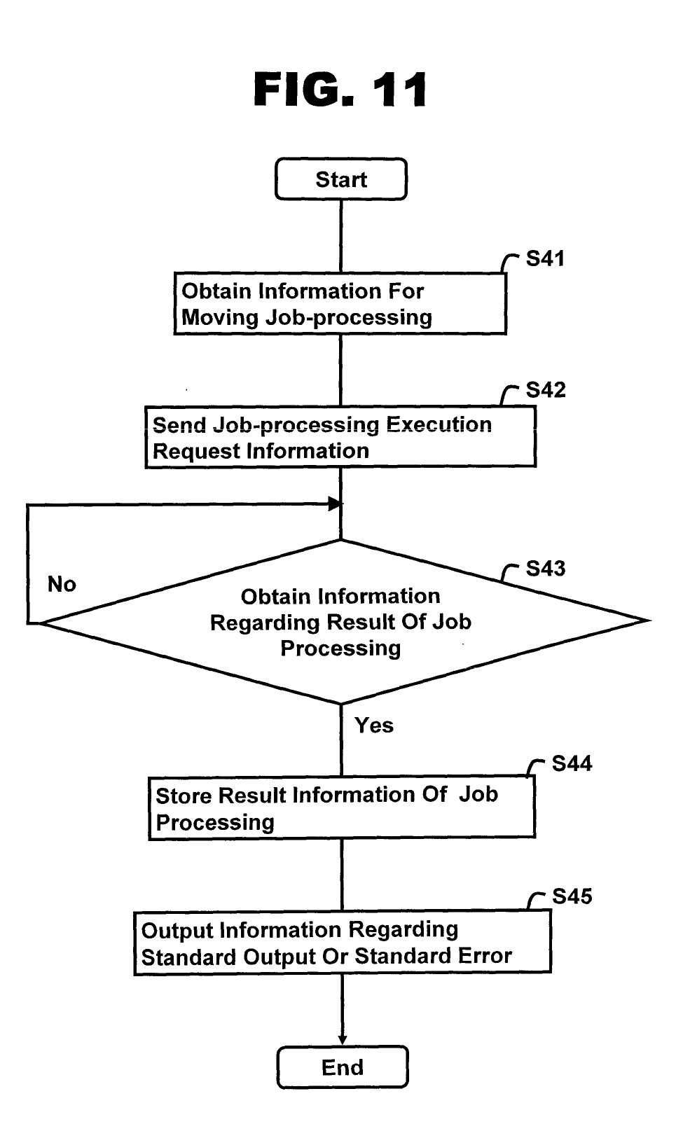

The move program 109 in this embodiment is executed by the control module 111 of the first job-processing apparatus 21. The move program 109 causes the first job-processing apparatus 21 to execute the following processing. FIG. 11 is a flowchart of moving processing of the job processing executed by the first job-processing apparatus 21.

In step S41, the first job-processing apparatus 21 obtains information for generating job-processing execution request information 196. The job-processing execution request information 196 includes, for example, the identification information regarding the second job-processing apparatus 22 to which the job processing is moved, information regarding the name of the job execution file, information regarding the input-data file 173 used for executing the job processing operation specified by the job execution file, and the identification information regarding the first job-processing apparatus 21 that is the sender.

In step S01 shown in FIG. 5A and FIG. 5B, the management server 10 receives, from the user terminal, the job execution file 171 that is necessary for the job processing, and stores the job execution file 171 in the storage module 104 of the management server 10. Here, the filename of the job execution file “b” 171-2 corresponding to the job processing operation “b” executed by the second job-processing apparatus 22 is the filename of the move program 109 (hereinafter referred to as a replacement-and-move program 109-1) whose name is replaced in step S34 in FIG. 10. The filename of the replacement-and-move program 109-1 is changed to the name of a job execution file by the management server 10. Thus, from the filename of the replacement-and-move program 109-1, the management server 10 can obtain the information regarding the name of the job execution file that is associated with the job processing. For example, in Perl, information regarding a filename is stored in argument information argv[0] of the main function. This enables the first job-processing apparatus 21 to refer to the information regarding the filename from the replacement-and-move program 109-1. As a result, no processing in which the information regarding the name of the job execution file is additionally stored is necessary.

In step S42, the first job-processing apparatus 21 sends the job-processing execution request information 196 to the second job-processing apparatus 22. The first job-processing apparatus 21 sends information regarding, for example, a standard input, a job execution file, and input data necessary for performing job processing to the second job-processing apparatus 22. The information regarding the standard input includes, for example, a command to cause the second job-processing apparatus 22 to start the execution of the job processing and a piece of input information necessary for performing the job processing.

The first job-processing apparatus 21 waits until the job processing executed in the second job-processing apparatus 22 is finished and the first job-processing apparatus 21 obtains the information regarding the result of the job processing (NO in step S43). Although it seems that the first job-processing apparatus 21 has executed the job processing operation “b”, the second job-processing apparatus 22 executes the job processing operation “b”. The second job-processing apparatus 22 sends the information regarding the execution result of the job processing, and the information regarding a standard output or standard error output from the second job-processing apparatus 22 to the first job-processing apparatus 21. The information regarding the apparatus to which the second job-processing apparatus 22 sends certain information is extracted from the identification information regarding the first job-processing apparatus 21 that is the sender, the identification information being included in the job-processing execution request information 196 regarding the job processing. Here, the information regarding the result of the job processing includes the job processing result information and the information regarding the standard output in the case of normal completion or regarding the standard error in the case of abnormal completion. For example, when the management server 10 sends a job-processing request to the second job-processing apparatus 22, the management server 10 generates in advance a procedure file including the procedure of sending the information regarding the standard output or standard error as file information to the job-processing apparatus that has requested the job processing. The second job-processing apparatus 22 can send the information regarding the standard output or standard error to the first job-processing apparatus 21 by executing the procedure file.

If the first job-processing apparatus 21 obtains the information regarding the result of the job processing after the job processing is finished in the second job-processing apparatus 22 (YES in step S43), in step S44, the obtained information regarding the result of the job processing and the like are stored in the preset area where the output result should be stored. For example, if the first job-processing apparatus 21 executes the job processing operation “b”, the information regarding the result of the job processing operation “b” is stored in the area where the processing result of the job processing operation “b” should be stored.

In step S45, the first job-processing apparatus 21 obtains the information regarding the standard output or standard error from the second job-processing apparatus 22 in a file format, and outputs the information regarding the standard output or standard error. The first job-processing apparatus 21 stores a file of the standard output obtained from the second job-processing apparatus 22 in an area to which the file of the standard output is output as the standard output of the first job-processing apparatus 21, or the first job-processing apparatus 21 stores a file of the standard error obtained from the second job-processing apparatus 22 in an area to which the file of the standard error is output as the standard error of the first job-processing apparatus 21. If the first job-processing apparatus 21 executes the job processing operation “b”, the information regarding the standard output or standard error is stored in an area where the information regarding the standard output or standard error should be stored.

In response to the information regarding the result of the job processing, the first job-processing apparatus 21 subsequently executes job processing. The processing operations of the move program 109 have been described above. For the following description, please refer to FIG. 5A and FIG. 5B again.

In step S08, the first job-processing apparatus 21 sends a job-processing execution request 18-2 to the second job-processing apparatus 22 by executing the move program 109 that includes a processing command for moving the job processing to the second job-processing apparatus 22. In step S09, the second job-processing apparatus 22 sends a job-execution-file send request 185-2 to the management server 10 after obtaining the job-processing execution request 18-2. In step S10, the management server 10 generates a job program 19-2 that the second job-processing apparatus 22 needs in order to execute the job processing. In step S11, the management server 10 sends, to the second job-processing apparatus 22, the job program 19-2 that the second job-processing apparatus 22 needs in order to execute the job processing.

In step S12, the second job-processing apparatus 22 executes the job processing. The job processing executed by the second job-processing apparatus 22 is executed in the second job-processing apparatus 22. In step S13, when the job processing is finished, the second job-processing apparatus 22 sends job-processing result information 51 including the information regarding the result of the job processing and the information regarding the standard output or standard error to the first job-processing apparatus 21. In step S14, the first job-processing apparatus 21 subsequently executes job processing in response to the result of the job processing, the result being obtained from the second job-processing apparatus 22. In FIG. 5A and FIG. 5B, the first job-processing apparatus 21 executes the post-processing in the job processing operation “a”.

In step S15, the first job-processing apparatus 21 sends job-processing result information 52 to the management server 10 when the job processing operation “a” is finished.

In step S16, the management server 10 sends job-processing result information 53 to the user terminal.

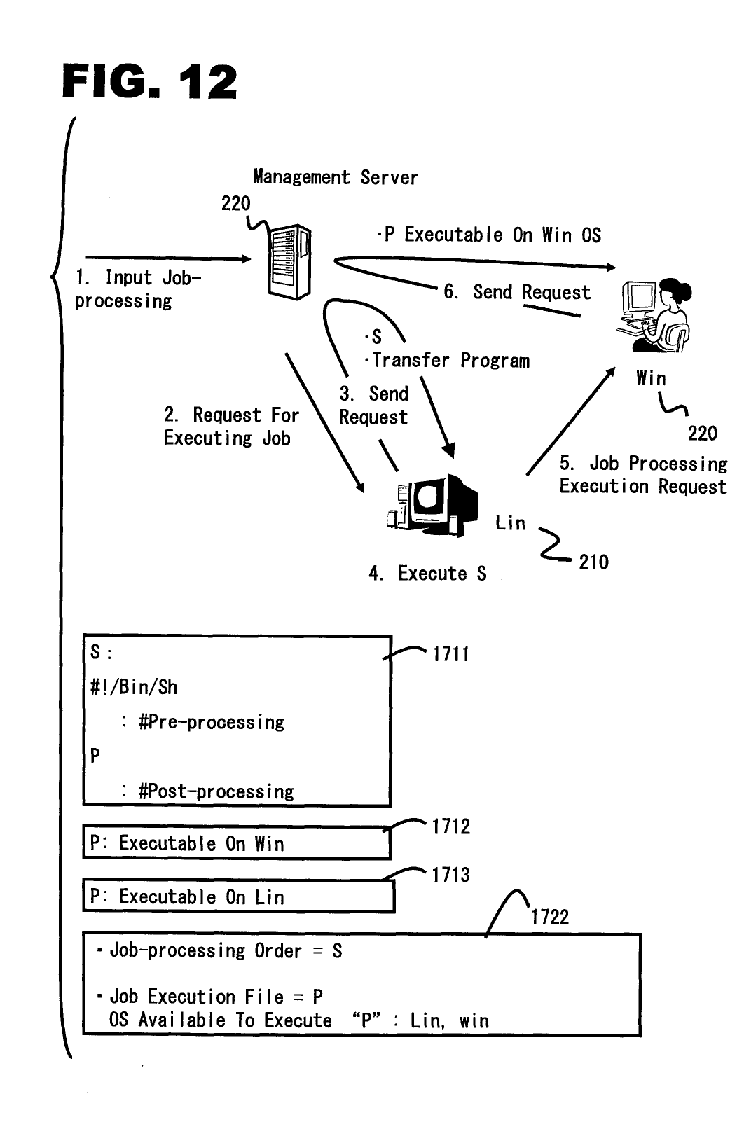

Next, an example of the embodiment will be described. FIG. 12 is a diagram showing an example of job processing. A job-processing request includes a job execution file “S” 1711, a job execution file “P” 1712 executable on Windows® OS, a job execution file “P” 1713 executable on Linux® OS, and a job-procedure file 1722. A job-processing apparatus with Linux® OS executes a job processing operation “S”, which is a shell script including pre-processing and post-processing. While the job processing operation “S” is performed, a job-processing apparatus with Windows® OS or Linux® OS executes a job processing operation “P” in the simulation. The job execution files “P” 1712 and 1713 are proprietary programs for the simulation. Users have the job execution file “P” 1712 executable on Windows® OS and the job execution file “P” 1713 executable on Linux® OS as binary files. If only job-processing apparatuses with Windows® OS are used, the job processing including the pre-processing and post-processing cannot be executed. Moreover, if only job-processing apparatuses with Linux® OS are used, job-processing apparatuses capable of executing job processing are limited in the grid computing system 1.

In operation (1) as shown in FIG. 12, a user inputs a job-processing request to the management server 10.

It is determined by the management server 10 that a job-processing apparatus lin210 executes the job processing operation “S”, and a job-processing apparatus win220 executes the job processing operation “p”.

In operation (2), the management server 10 sends a request for executing the job processing operation “S” to the job-processing apparatus lin210. When the job-processing apparatus lin210 receives the request for executing the job processing operation “S”, a control module of the job-processing apparatus lin210 executes deployment processing (deploy_require) for the job processing operation “S”. In operation (3), the job-processing apparatus lin210 sends a send request of the job execution file “S” 1711 and a send request of the job execution file “P” 1712 or 1713 to the management server 10.

The management server 10 sends the job execution file “S” 1711 to the job-processing apparatus lin210. The job processing operation “P” is determined to be executed by the job-processing apparatus win220, and thus the filename of a transfer program is changed to the name of the job execution file “P” and the transfer program is sent.

In operation (4), the job-processing apparatus lin210 executes the job processing. The job-processing apparatus lin210 executes the job processing operation “S” and proceeds to the job processing operation “P”. The job processing operation “P” is performed using a move program. In operation (5), the job-processing apparatus lin210 sends a job-processing execution request to the job-processing apparatus win220.

In operation (6), the job-processing apparatus win220 sends a send request of the job execution file “P” 1712 to the management server 10. The management server 10 has the job execution file “P” 1712 executable on Windows® OS and the job execution file “P” 1713 executable on Linux® OS. The management server 10 searches for the job execution file “P” 1712 that matches the information regarding the OS used by the job-processing apparatus win220, the information being included in a transfer request. The management server 10 sends the job execution file “P” 1712 executable on Windows® OS to the job-processing apparatus win220. The job-processing apparatus win220 executes the job processing operation “P”. The job-processing apparatus win220 sends the processing result of the job processing operation “p” to the job-processing apparatus lin210.

The job-processing apparatus lin210 obtains the information regarding the result of the job processing operation “P” performed by the job-processing apparatus win220. The job-processing apparatus lin210 subsequently executes the post-processing in the job processing operation “S”, and sends the result of the job processing operation “S” to the management server 10. The management server 10 sends the result of the job processing to the user.

If it is determined by the management server 10 that the job-processing apparatus lin210 executes the job processing operations “S” and “P”, the management server 10 sends the job execution files “S” 1711 and “P” 1713 to the job-processing apparatus lin210.

As described in the embodiment above, the management server 10 can cause processing operations to be executed by a plurality of job-processing apparatuses.

In the embodiments, a user of the grid computing system 1 merely performs the setting of conditions that enable the job processing to be executed, whereby the management server 10 can select an appropriate job-processing apparatus. Here, there is no need for the user to consider the move of the job processing between job-processing apparatuses. Moreover, there is no need for the user to change a job description for each job-processing apparatus. In addition, there is no need to install new software in such job-processing apparatuses. Moreover, since the number of job-processing apparatuses to which job-processing operations can be allocated by the management server 10 is increased, such job-processing operations can be allocated to the job-processing apparatuses with high job-processing performance in the grid computing system 1. By performing the setting of more detailed information in the job-processing-apparatus table 40, the management server 10 can determine a job-processing apparatus that executes job processing, for example, on the basis of the installed software. Furthermore, in the embodiment, such job processing can be executed even in a case in which three or more job processing operations are performed in a layer structure.

What is claimed is:

1. A computer readable medium storing a program used in a computer for executing a process for distributing jobs among a plurality of job processing devices for executing said jobs, respectively, said job including a plurality of job files, the process comprising,
a control module for executing a process comprising:
determining said job processing devices for executing said job files, respectively;
generating an execution file to be executed by one of said job processing devices after one of said job files is executed by said one of said job processing devices, said execution file when executed having said one of said job processing devises requests another of job processing devices to execute another of job files, said another of job files being executed by said another of said job processing devices subsequently to said job file executed by said one of said job processing devices; and
transferring said one of said job files and said execution file to said one of said job processing devices.

2. The computer readable medium according to claim 1, wherein the transferring step of said process transfers a result data to said one of said job processing devices, said result data being obtained from execution of said one of said job files by said one of said job processing devices.

3. The computer readable medium according to claim 1, said process further comprising the steps of:
obtaining said job and requirement information including the type of job processing device capable of executing said job file; and
determining said job processing devices for executing said job files on the basis of said requirement information.

4. The computer readable medium according to claim 1, wherein said step of said generating of said process generates said job file and said execution file upon receiving a request from said one of said job processing devices for transferring said job file.

5. The computer readable medium according to claim 1, wherein said step of said transferring of said process transfers to said one of said job processing devices executing said job file being first listed in the job.

6. A method for controlling a processing device for distributing jobs among a plurality of job processing devices for executing said jobs, respectively, said job including a plurality of job files, the method comprising the steps of:
determining said job processing devices for executing said job files, respectively;
generating an execution file to be executed by one of said job processing devices after one of said job files is executed by said one of said job processing devices, said execution file when executed having said one of said job processing devises requests another of job processing devices to execute another of job files, said another of job files being executed by said another of said job processing devices subsequently to said job file executed by said one of said job processing devices; and
transferring said one of said job files and said execution file to said one of said job processing devices.

7. The method according to claim 6, wherein the transferring step transfers a result data to said one of said job processing devices, said result data being obtained from execution of said one of said job files by said one of said job processing devices.

8. The method according to claim 6, further comprising the steps of:
obtaining said job and requirement information including the type of job processing device capable of executing said job file; and
determining said job processing devices for executing said job files on the basis of said requirement information.

9. The method according to claim 6, wherein said step of said generating generates said job file and said execution file upon receiving a request from said one of said job processing devices for transferring said job file.

10. The method according to claim 6, wherein said step of said transferring transfers to said one of said job processing devices executing said job file being first listed in the job.

11. A processing device for distributing jobs among a plurality of job processing devices for executing said jobs, respectively, said job including a plurality of job files, the processing device comprising,
a control module for executing a process comprising:
determining said job processing devices for executing said job files, respectively;
generating an execution file to be executed by one of said job processing devices after one of said job files is executed by said one of said job processing devices, said execution file when executed having said one of said job processing devises requests another of job processing devices to execute another of job files, said another of job files being executed by said another of said job processing devices subsequently to said job file executed by said one of said job processing devices; and
transferring said one of said job files and said execution file to said one of said job processing devices.

12. The processing device according to claim 11, wherein the transferring of said process transfers a result data to said another of said job processing devices, said result data being obtained from execution of said one of said job files by said one of said job processing devices.

13. The processing device according to claim 11, wherein said process further comprises:
obtaining said job and requirement information including the type of job processing device capable of executing said job file; and
determining said job processing devices for executing said job files on the basis of said requirement information.

14. The processing device according to claim 11, wherein said process of said generating generates said job files and said execution file upon receiving a request for transferring said job file from said job processing device.

15. The processing device according to claim 11, wherein said transferring of said process transfers to said one of said job processing devices executing said one of said job files being first listed in the job.
